(19) United States
(12) Patent Application Publication
(10) Pub. No.: US 2020/0189059 A1
(43) Pub. Date: Jun. 18, 2020

(54) WORK TOOL AND DUST EXTRACTION DEVICE THEREOF

(71) Applicant: DIAGER, Poligny (FR)

(72) Inventor: François DEFOUGERES, POLIGNY (FR)

(21) Appl. No.: 16/715,650

(22) Filed: Dec. 16, 2019

(30) Foreign Application Priority Data
Dec. 14, 2018 (FR) 1872961

(51) Int. Cl. B23Q 11/00

(52) U.S. Cl. CPC B23Q 11/0046; B23B 2270/62; B23B 2251/68

(57) ABSTRACT

A work tool equipped with a dust extraction device, the piercing tool includes a working head secured to a drive spindle, the extraction device has an extraction tube mounted around the drive spindle and a first end of which is mounted on a sleeve, the sleeve being mounted so as to rotate freely on the drive spindle of the piercing tool and being connected to a device generating a negative pressure in the extraction tube, wherein at least a portion of the circumference of the second end of the tube is in contact with the drilling head, the extraction device includes a vent formed between the second end of the tube and the working head.

### CROSS REFERENCE TO RELATED APPLICATION

This application is related to and claims the benefit of French Patent Application Number FR1872961 filed on Dec. 14, 2018, the contents of which are hereby incorporated by reference in their entirety.

### TECHNICAL FIELD

The disclosure relates to the field of work tools and more particularly piercing tools of the drill type, striking tools or percussion tools, and comprising a device for extracting the dust generated during the operation of drilling a hole.

### BACKGROUND

The document DE 3340090 discloses a piercing tool comprising a dust extraction device. This extraction device comprises a tube in which a piercing drill is mounted, wherein the diameter of the drive spindle is slightly less than the diameter of the tube. The tube is connected by one end to an extraction device. The other end of the tube is distant from the drill in order to provide an orifice for extraction of the dust between the drill and the internal wall of the tube. The dimensions of the tube must be adjusted to the dimension of the drill. It is therefore necessary to have an extraction tube for each drill diameter.

### BRIEF SUMMARY

One aim of the present disclosure is to respond to the drawbacks of the document of the prior art mentioned above and in particular to provide optimum extraction efficacy for various drill diameters.

For this purpose, a first aspect of the disclosure relates to a work tool equipped with a dust extraction device, the work tool comprises a working head secured to a drive spindle, the extraction device comprises an extraction tube mounted around the drive spindle and a first end of which is mounted on a sleeve, the sleeve being mounted so as to be able to rotate freely on the drive spindle of the work tool and being connected to a device generating a negative pressure in the extraction tube, characterized in that at least a portion of the circumference of the second end of the tube is in contact with the working head, the extraction device comprises a vent formed between the second end of the tube and the working head.

It will be understood that the dimensions of the extraction tube are independent of the dimensions of the spindle and that the dimensions of the second end of the tube can allow use with a plurality of drilling spindles. Moreover, the extraction of the dust is concentrated at the vent situated as close as possible to the drilling zone of the tool, which increases the extraction efficacy.

According to another alternative embodiment, the vent is formed by a groove on the external surface of the working head.

According to another alternative embodiment, the vent is formed by a protrusion on the periphery of the second end of the extraction tube.

According to another alternative embodiment, the drilling head comprises a shoulder forming a surface for receiving the second end of the extraction tube.

According to another alternative embodiment, the vent emerges in a channel passing through the working head.

According to another alternative embodiment, a means of coupling between the sleeve and the extraction tube is arranged so as to ensure centering of the tube on the drive spindle.

According to another alternative embodiment, the coupling means comprises a ring secured to the sleeve, the ring comprising a lug engaging with a notch formed on the first end of the extraction tube in order to lock the rotation of the extraction tube with respect to the sleeve.

According to another alternative embodiment, the ring is in two parts.

According to another alternative embodiment, the ring comprises an internal groove arranged so as to provide communication between the internal volume of the extraction tube and the device generating the negative pressure.

According to another alternative embodiment, the sleeve comprises an internal annular surface for contact with a corresponding annular surface of the spindle of the tool.

According to another alternative embodiment, the spindle of the work tool comprises a first portion comprising the working head and a second separate driving portion, the two portions being assembled at or upstream of the sleeve.

According to another alternative embodiment, the work tool comprises an insert arranged between the extraction tube and the working head, the vent being arranged at least partly in the insert.

According to another alternative embodiment, the work tool is a piercing tool and the working head is the piercing head of the tool.

### BRIEF DESCRIPTION OF THE DRAWINGS

Other features and advantages of the present disclosure will emerge more clearly from a reading of the following detailed description of an embodiment of the disclosure given by way of an in no way limitative example and illustrated by the accompanying drawings, in which:

FIG. 1 shows a side view of the piercing tool and the dust extraction device thereof according to the disclosure;

FIG. 2 shows a view of details of the drilling head of the piercing tool and the dust extraction device thereof;

FIG. 3 shows a view of details of the drilling head of the piercing tool;

FIG. 4 shows a view in exploded perspective of the piercing tool and the dust extraction device thereof;

FIG. 5 shows a view of details of the sleeve of the extraction device;

FIG. 6 shows a view of details of a second alternative embodiment of the drilling head of the piercing tool and the dust extraction device thereof.

### DETAILED DESCRIPTION

The following description is made with reference to a piercing tool comprising a drilling head. However, without departing from the scope of the disclosure, it also applies to other work tools comprising a working head such as a striking tool or a percussion tool. Dust is also intended to mean debris and swarf.

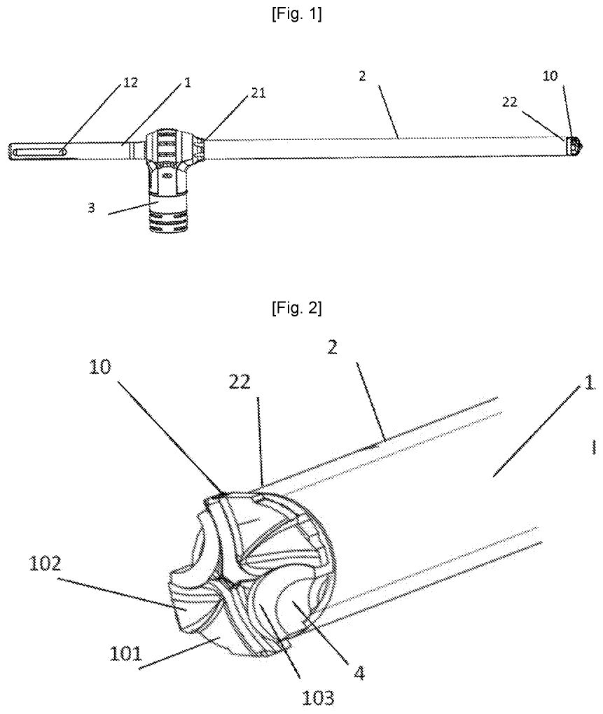

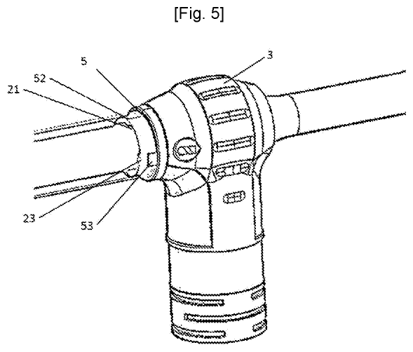

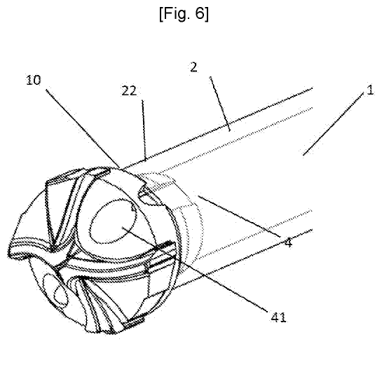

The piercing tool and the dust extraction device thereof according to the disclosure will now be described with reference to FIGS. 1 to 5.

The piercing tool comprises, in a manner known per se, a drive spindle 1 comprises a working head, here a drilling head 10 at one of the ends 11 thereof, the other end 12 is conformed so as to come to be inserted in a chuck of a piercing apparatus (not shown). The extraction device as such comprises an extraction tube 2 in which the drive spindle 1 is inserted. The dimensions of the extraction tube are chosen so that the drive spindle 1 can rotate freely in the extraction tube 2. The extraction device also comprises a sleeve mounted so as to rotate freely on the drive spindle 1. Thus the sleeve 3 comprises an orifice 30 through which the drive spindle 1 passes. At the interface between the drive spindle 1 and the orifice 30 of the sleeve 3, the spindle comprises a bulge 13, the diameter of which corresponds substantially to the inside diameter of the orifice 30 of the sleeve 3. This interface between the sleeve 3 and the bulge on the spindle 1 creates a sufficient seal in the sleeve 3 to maintain a negative pressure in the extraction tube 2.

The first end 21 of the extraction tube 2 is mounted on the extraction sleeve 3. The extraction tube 2 in aeraulic connection with the sleeve 3. The sleeve 3 is connected to a means for generating a negative pressure in the extraction tube 2. Because of the dimensions of the extraction tube 2 and of the drive spindle 1, the space delimited by firstly the internal surface of the extraction tube 2 and secondly the external surface of the drive spindle 1 defines a substantially annular extraction chamber. The extraction flow is then created in this extraction chamber. The shape of the chamber facilitates the extraction and reduces the risks of clogging between the external surface of the drive spindle 1 and the internal surface of the extraction tube 2.

According to an alternative embodiment, at least a portion of the circumference of the second end 22 of the extraction tube 2 is in contact with the drilling head 10 of the piercing tool. Moreover, the extraction device comprises at least one vent 4 formed between the drilling head 10 and the second end of the extraction tube. It will be understood that the partial contact between the circumference of the second end 22 of the extraction tube 2 and the drilling head concentrates the negative pressure created in the extraction tube 2 at the vent or vents 4, which increases the extraction efficacy. The drilling head 10 may comprise a shoulder 14 on which the portion of the circumference of the second end of the extraction tube comes into abutment.

According to the alternative embodiment shown, each vent 4 is formed by a groove on the drilling head produced facing the second end 22 of the extraction tube 2. According to another alternative, each vent 4 is formed by a protrusion produced on the periphery of the second end 22 of the extraction tube 2 facing the external surface of the drilling head 10. Each vent can emerge on the top of the drilling head in order to be as close as possible to the dust to be extracted. It is also possible to provide an insert (not shown) in the interface zone between the extraction tube 2 and the external surface of the drilling head 10. This insert comprises at least partly the vent or vents 4 and provides the sliding of the extraction tube 2 on the drilling head 10. The insert is either secured to the end of the extraction tube 2 or secured to the drilling head 10.

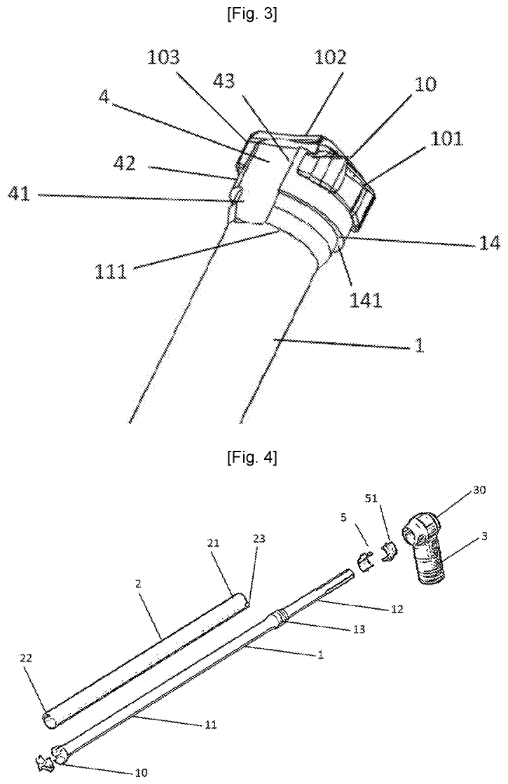

As shown on the embodiment in FIGS. 1 to 4, in particular illustrated by FIG. 3, each vent 4 is formed by an axial groove, or recess, forming a concave cylindrical wall 41 in the external axial surface of the drilling head 10. The concave cylindrical wall 41 has a cross section in an arc of a circle. The vent 4 extends axially from the end of the drive spindle 1, at the junction 111 with the drilling head 10, as far as the surface 101 of the drilling head 10. The vent 4 thus comprises two ridges 42, 43 each extending roughly in an axial direction in order to define the lateral edges of the vent 4. Preferably, the drilling head 10 comprises two diametrically opposed vents 4. The working zone 102 of the drilling head 10 is arranged on the surface 101 of the drilling head 10. The working zone 102 of the drilling head 10 here comprises two diametrically opposed notches 103 that respectively enable each vent 4 to emerge in the surface 101 of the drilling head 10. From the junction 111, the drilling head 10 gradually increases in diameter until it forms the shoulder 14, which defines an annular radial surface 141 oriented towards the extraction tube 2.

According to the alternative embodiment in FIG. 6, the vent 4 may be extended in the drilling head 10 by a channel 41 that emerges on the surface of the drilling head 10. This channel 41 in particular makes it possible to extract the dust as close as possible to the working zone of the drilling tool. Likewise, the presence of the channel 41 makes it possible to extract more dust at the very start of the piercing operation.

The extraction tube 2 can be assembled on the sleeve 3 by a coupling means 5. This coupling means in particular allows the centering of the extraction tube 2 on the drive spindle 1. More precisely, the coupling means 5 provides the centering of the extraction tube 2 on the first end 11 of the drive spindle 1. This coupling means 5 also enables the extraction tube 2 to be removed from the sleeve 3.

The coupling means comprises for example a ring 5 providing the mechanical interface between the sleeve 3 and the extraction tube 2. The ring 5 is mounted firstly in the sleeve 3, substantially coaxially with the longitudinal axis of the drive spindle 1. The ring 5 comprises for example a first collar 51 engaging in the sleeve 3.

The ring 5 also comprises a second collar 52 on which the first end of the extraction tube 2 engages. The outside diameter of the second collar 52 corresponds substantially to the inside diameter of the first end 21 of the extraction tube. This makes it possible firstly to center the tube with respect to the drive spindle 1 and secondly to create a clearance between the drive spindle 1 and the extraction tube 2. The inside diameter of the ring 5 is sufficiently large to enable the drive spindle 1 to rotate.

The ring 5 also comprises a lug 53 on which a notch 23 of the second end 22 of the extraction tube 2 engages. The extraction tube 2 is then rotationally locked with respect to the sleeve 3. Likewise, the tube 2 is also rotationally locked with respect to the drive spindle 1. In this configuration, the user can grip the extraction tube 2 when carrying out piercing without any risk of injury.

When the extraction tube 2 is not rotationally locked, it can be rotated in particular by the friction of the first end 21 of the extraction tube 2 on the drilling head 10. However, a user can grip the extraction tube 2 despite everything since the drive torque of the extraction tube 2 is very low.

The inside diameter of the ring 3 may also comprise ribs for providing aeraulic communication between the extraction tube 2 and the sleeve 3. These ribs may be produced alternately or cumulatively on the body of the sleeve 3. According to the alternative embodiment shown, the ring 5 is in two parts. Likewise, it is possible to provide several types of ring 5 adapting to the various diameters of the extraction tube 2.

According to another alternative embodiment that is not shown, the spindle 1 of the piercing tool is in two parts corresponding respectively to the first and second end 11, 12 of the spindle 1. The assembly is carried out in a manner known per se, for example at the bulge 13. It will be understood that various modifications and/or improvements that are obvious to a person skilled in the art may be made to the various embodiments of the disclosure described in the present description without departing from the scope of the disclosure defined by the accompanying claims. Thus, by way of non-limitative example, the extraction tube 2 may be rotated with the drive spindle 1. To do this, coupling means are provided so as not to rotationally lock the extraction tube with respect to the drive spindle. The contact between the drilling head and the extraction tube makes it possible for example to rotate the extraction tube.

According to an alternative embodiment that is not shown, the space between the extraction tube and the drive spindle may comprise a tongue, the general orientation of which is substantially parallel to the axis of the extraction tube and arranged to form a scraper limiting the risk of clogging of the space between the extraction tube and the drive spindle. This tongue may also prevent squashing of the extraction tube against the drive spindle in the event of impact.

1. Work tool equipped with a dust extraction device, the work tool comprising a working head secured to a drive spindle, the extraction device comprising an extraction tube mounted around the drive spindle, a first end of which is mounted on a sleeve, the sleeve being mounted so as to rotate freely on the drive spindle of the work tool and being connected to a device generating a negative pressure in the extraction tube, the space delimited by firstly the internal surface of the extraction tube and secondly by the external surface of the drive spindle defining a substantially annular extraction chamber, at least a portion of the circumference of the second end of the tube being in contact with the working head, wherein the extraction device comprises a vent formed between the second end of the tube and the working head and formed by a groove on the external surface of the working head.

2. Work tool equipped with a dust extraction device according to claim 1, wherein the groove forming the vent is formed by a concave cylindrical wall formed in the external axial surface of the drilling head.

3. Work tool equipped with a dust extraction device according to claim 2, wherein the concave cylindrical wall has a cross section in an arc of a circle.

4. Work tool equipped with a dust extraction device according to claim 1, wherein the vent extends axially from the end of the drive rod, at the junction with the drilling head, to the surface of the drilling head.

5. Work tool equipped with a dust extraction device according to claim 4, wherein the drilling head increases gradually in diameter from the junction until it forms a shoulder that defines an annular radial surface oriented towards the extraction tube.

6. Work tool equipped with a dust extraction device according to claim 1, wherein the vent is formed by a protrusion on the periphery of the second end of the extraction tube.

7. Work tool equipped with a dust extraction device according to claim 1, wherein the working head comprises a shoulder forming a surface for receiving the second end of the extraction tube.

8. Work tool equipped with a dust extraction device according to claim 1, wherein it comprises a means of coupling between the sleeve and the extraction tube arranged so as to ensure centering of the tube on the drive spindle.

9. Work tool equipped with a dust extraction device according to claim 1, wherein the coupling means comprises a ring mounted on the sleeve, the ring comprising a lug engaging with a notch formed on the first end of the extraction tube in order to lock the rotation of the extraction tube with respect to the sleeve.

10. Work tool equipped with a dust extraction device according to claim 9, wherein the ring is in two parts.

11. Work tool equipped with a dust extraction device according to claim 9, wherein the ring comprises an internal groove arranged so as to provide communication between the internal volume of the extraction tube and the device generating the negative pressure.

12. Work tool equipped with a dust extraction device according to claim 1, wherein the sleeve comprises an internal annular surface for contact with a corresponding annular surface of the spindle of the tool.

13. Work tool equipped with a dust extraction device according to claim 1, wherein the spindle of the work tool comprises a first portion comprising the working head and a second separate drive portion, the two portions being assembled at or upstream of the sleeve.

14. Work tool equipped with a dust extraction device according to claim 1, wherein it comprises an insert disposed between the extraction tube and the working head, the vent being arranged at least partly in the insert.

15. Work tool equipped with a dust extraction device according to claim 1, wherein the work tool is a piercing tool and the working head is the piercing head of the tool.
